(19) United States
(12) Patent Application Publication
(10) Pub. No.: US 2010/0005692 A1
(43) Pub. Date: Jan. 14, 2010

(54) RE-ATTACHABLE CONTAINER IDENTIFIERS

(76) Inventors: Donald Farnsworth, Oakland, CA (US); John Nava, Ojai, CA (US); Jill Wild, Berkeley, CA (US); Marc Hankin, Los Angeles, CA (US)

Correspondence Address: MARC E. HANKIN, ESQ., 11414 THURSTON CIRCLE, LOS ANGELES, CA, 90049, US

(21) Appl. No.: 12/564,815

(22) Filed: Sep. 22, 2009

Related U.S. Application Data
(63) Continuation-in-part of application No. 11/256,545, filed on Oct. 21, 2005.

(51) Int. Cl. G09F 3/00

(52) U.S. Cl. 40/324

(57) ABSTRACT

This invention is a product for identifying wine transferred into glasses from a wine bottle by using removable labels that are packaged along with the wine bottle's labels. The invention allows one to identify the wine once it is poured into a glass and/or distinguish among multiple wine glasses into which the same wine is poured. Several embodiments of the invention are particularly suited to the practice of wine tasting, where it is important to identify the wine poured into a glass as well as distinguish between the glasses of different tasters.

### CROSS-REFERENCE TO RELATED APPLICATIONS

This application is a continuation-in-part of U.S. Non-Provisional patent application Ser. No. 11/256,545, filed on Oct. 21, 2005, entitled “Re-Attachable Container Identifiers” to inventors Donald Farnsworth, John Nava, Jill Wild, and Marc Hankin, the contents of which are expressly incorporated herein as though set forth in its entirety.

### FIELD OF INVENTION

This invention relates, generally, to container labels; more particularly to container labels that are removable and re-attachable to assist in identifying the source of a material once distributed from a larger container into a smaller unlabeled container and/or labels that serve to distinguish among multiple smaller unlabeled containers containing the said material.

### BACKGROUND

The practice of wine tasting often involves the sampling of numerous producers, types, and vintages of wine in comparison with one another. Ordinarily, the taster is presented with the varieties of wine in a series of glasses, commonly referred to as a flight. Because the wines presented to the taster in the individual glasses are poured from different wine bottles, a problem of identifying the source of a specific glass's wine often arises. This problem is commonly solved by placing the glasses in a specific order, which is committed to memory, or by placing handwritten labels underneath each glass. Each of these solutions presents its own difficulties because one's recollection of the wine type can be impaired by the social activities or inebriation that often accompany wine tasting. Also, handwritten labels are cumbersome, unsightly, and can become easily misplaced or stained in the course of the wine tasting.

Further, when wines are poured into different glasses for different tasters at social functions, the problem arises of identifying which glass belongs to whom. In order to avoid the social disgrace of drinking from another's glass and the spread of germs, disposable and reusable wine glass stem labels have been developed. These “glass charms” known in the art commonly act as necklaces that attach to the wine glass stem and identify the glass's owner by name or by a unique color or design. These glass charms, however, are often expensive and/or inconvenient because they must be purchased and/or brought separately to a wine tasting.

Similar problems arise anytime a material is transferred from one source container into several, unlabeled, containers. For example, chemists working in a laboratory can encounter similar difficulties if a container of a given compound is poured into several, smaller, unlabeled test tubes.

One solution to identifying wine is disclosed in U.S. Pat. No. 6,520,543, issued to Hoar. Hoar discloses a sheet of vinyl chloride wine labels that are shipped with a case of wine. The labels are attached via static cling to wine glasses by a restaurant so that a patron can identify what wine is being drunk. However, Hoar does not disclose that the labels help distinguish one drinker's glass from another drinker's glass. Specifically, nothing in Hoar indicates that the labels in the sheet are anything but identical. Additionally, Hoar fails to disclose that the labels are first affixed to the wine bottle itself. Finally, Hoar does not provide for labels that can be wrapped around the stem of a wine glass, because a vinyl label is not physically capable of wrapping around a stem and sticking to itself.

Another wine identification system is disclosed by U.S. Pat. No. 5,924,739, issued to Garbutt. Garbutt discloses a single identification sheet that is contained within the capsule of a wine bottle. The identification sheet is designed to be detachable so that the owner of the bottle of wine has a record of what wine was drunk and other detailed information about the wine. Importantly, Garbutt utterly fails to disclose, teach, or suggest removing the capsule identification sheet and attaching it to a wine glass. Garbutt also fails to disclose two or more labels that are different and help distinguish between the glasses of two different drinkers.

Another label identification system is disclosed by U.S. Pat. No. 5,958,536, issued to Gelsinger. Gelsinger discloses a pharmaceutical stock bottle that has a plurality of labels that, when attached to secondary bottles, identify the contents of the secondary bottle. However, Gelsinger does not disclose that the labels are attached to a wine bottle. Additionally, Gelsinger does not disclose that the removable stock bottle labels have differentiating marks so that a user can distinguish between various secondary bottles. Indeed, it is very important to Gelsinger that the secondary prescription bottles must be marked with precise and identical information. As such, Gelsinger specifically teaches away from an identification system that allows wine drinkers to distinguish wine glasses.

Therefore, there is a long-felt need in the art for a series of wine labels that can be easily removed and re-affixed to wine glasses in order to identify the source of material distributed and/or a label that distinguishes multiple wine glasses containing the same wine.

### SUMMARY OF THE INVENTION

This invention is directed towards overcoming the above problems by providing easily removable labels as part of the source container's packaging that can be affixed to smaller containers into which the material is poured. Removable labels are included with the capsule or container label on the container at the time of distribution. These labels can identify the brand, year, type, and/or any other pertinent information desired. Additionally, the individual labels on the container can be of different colors, in order to distinguish among the smaller containers onto which they are re-affixed. Upon serving or pouring the material, the labels are removed and affixed to the smaller container into which the material is distributed.

This allows each smaller container to be uniquely identified and also indicate the source of the material it contains. This is accomplished without the need for additional appurtenances such as labels or writing utensils and with a minimum of effort on the part of the server and taster.

In the practice of wine tasting, the labels can also be maintained by the taster in order to keep a record or log of wines he or she has tasted.

One embodiment of the invention is a product for identifying wine, comprising: a wine bottle with one or more labels; the labels are removable; the labels include identifying words, symbols, marks, characters, and/or colors; the labels are removed from the wine bottle and are affixed to one or more wine glasses into which the wine is poured; wherein the labels identify the type or source of the wine. The wine bottle includes a plurality of labels of different colors that are used to distinguish between the one or more wine glasses into which the wine is poured and the plurality of labels include information to identify the source or type of wine. The wine glasses have a stem, and the labels are wrapped around the stems such that the stems are completely encircled by the labels. The removable labels are derived from the capsule of the wine bottle and affixed to the wine glasses. The capsule is color coded on an inside surface so as not to change the standard look of the capsule. The capsule of the wine bottle may include a pull ring to facilitate easy removal of the capsule and separation of the labels. The removable labels may be included on one of the several bottle labels included with the bottle of wine. The labels may be included as part of a label cylinder that is packaged along with the wine bottle and wraps around the neck of the wine bottle.

Another embodiment of the invention is a product for distinguishing among wine glasses into which a wine is transferred from a wine bottle, comprising: a wine bottle with labels, the labels being removable; wherein each label is distinguishable from the other labels by color, pattern, or other identifying feature; wherein the labels are removed from the wine bottle and are affixed to the wine glasses into which the substance is poured; the label serves to distinguish among the wine glasses into which the wine is poured. The wine glasses have a stem, and the labels are wrapped around the stems such that the stems are completely encircled by the label. The removable labels are derived from the capsule of the wine bottle and affixed to the wine glasses. The capsule is color coded on an inside surface so as not to change the standard look of the capsule. The capsule of the wine bottle may include a pull ring to facilitate easy removal of the capsule and separation of the labels. The removable labels may be included on one of the several bottle labels included with the bottle of wine. The removable label may be derived from the top of the capsule of the wine bottle and affixed to the wine glasses. The labels may be included as part of a label cylinder that is packaged along with the wine bottle and wraps around the neck of the wine bottle.

Another embodiment of the invention is a product for identifying wine and/or distinguishing between wine glasses wherein the removable labels are flexible rings that are packaged beneath the capsule of a wine bottle. The capsule of the wine bottle may include a pull ring to facilitate easy removal of the capsule and separation of the labels. The removable labels may be included on one of the several bottle labels included with the bottle of wine.

Another embodiment of the invention is a product for identifying wine and/or distinguishing wine glasses wherein the labels are included as part of a label card that can be packaged along with the wine bottle. The label card is delivered attached to the side of a box of wine. The labels may be delivered facing inwards and the label card removable from the box to expose the labels. The label card may be delivered in an envelope attached to the side of a box of wine.

Another embodiment of the invention is a product for identifying wine and/or distinguishing wine glasses a cameo attached to the wine bottle is used to label the wine glasses.

Another embodiment of the invention is a product for identifying wine and/or distinguishing wine glasses wherein re-attachable container identifiers are integrated to the capsule of a screw cap type wine bottle.

Another embodiment of the invention is a product for identifying wine and/or distinguishing wine glasses wherein re-attachable container identifiers are attached to the neck of a screw cap type wine bottle.

Another embodiment of the invention is a product for identifying wine and/or distinguishing wine glasses wherein the larger container includes a removable leader tape, the leader tape holds the labels.

Another embodiment of the invention is a product for identifying wine and/or distinguishing wine glasses wherein the larger container is a box of wine.

Another embodiment of the invention is a product for identifying wine and/or distinguishing wine glasses wherein the label can be maintained by the user in a book or diary in order to maintain a log of the substances in the larger container.

Another embodiment of the invention is a product for identifying wine and/or distinguishing wine glasses wherein the labels have a tear off tab that the user affixes to a personal item and wherein the remainder of the label is affixed to the wine glass. Preferably the tear off tab is disconnected at a scored or perforated area.

Another embodiment of the invention is a product for identifying wine and/or distinguishing wine glasses wherein the removable labels are elastic bracelet rings that are snuggly wrapped around the exterior of the bottle. The elastic bracelet rings are wrapped around the base of the bottle. Alternatively, the elastic bracelet rings are wrapped around the neck of the bottle. The elastic bracelet rings may include a cameo or identification information. The elastic bracelet rings may be color coded. The identification information may be a plurality of alphabetical tabs. The bottle may be shaped such that the elastic bracelet rings fit into a groove in the bottle and are protected during shipping by an overhang.

In another embodiment of the invention the label is scored with a tear line and a tear tab is torn from the label so that it can be affixed to personal item. The removed tab has the same distinguishing mark as the label so that the labeled glass matches the removed tab.

Another embodiment of the invention is a method of identifying wine in a wine glass, the steps comprising: providing a wine bottle; wherein the wine bottle has one or more labels; wherein the one or more labels have identifying marks that identify a wine contained in the wine bottle; wherein the labels are removable; providing one or more wine glasses; attaching the removable labels to the wine glasses; pouring the wine into the wine glasses with the removable labels; and using the removable label to identify the wine poured into the wine glasses. Preferably, the identifying marks are selected from the group consisting of colors, patterns, symbols, characters, letters, and words. The labels further comprise distinguishing marks. The method preferably includes the steps of: distinguishing the labeled wine glasses from one another by the distinguishing marks; wherein the distinguishing marks are selected from the group consisting of colors, patterns, symbols, characters, letters, and words; wherein the wine glasses have stems; attaching the removable labels to the stems such that the labels completely encircle the stems; wherein the labels include tear tags; wherein the tear tags include the same the distinguishing marks of the labels; removing the tear tags from the labels before attaching the labels to the plurality of wine glasses; attaching the tear tags to one or more personal items; and identifying the wine glasses by matching the tear tags attached to the one or more personal items with the plurality of labels attached to the plurality of wine glasses.

Another embodiment of the invention is a method of distinguishing among wine glasses into which a wine is transferred from a wine bottle, the steps comprising: providing a wine bottle; wherein the wine bottle has a plurality of labels; wherein the plurality of labels have distinguishing marks; wherein the labels are removable; providing a plurality of wine glasses; attaching the removable labels to the wine glasses such that each of the plurality of wine glasses has a different one of the distinguishing marks; pouring the wine into the wine glasses with the removable labels; distinguishing the labeled wine glasses from one another by the distinguishing marks; wherein the distinguishing marks are selected from the group consisting of colors, patterns, symbols, characters, letters, and words; wherein the wine glasses have stems; attaching the removable labels to the stems such that the labels completely encircle the stems; wherein the labels include tear tags; wherein the tear tags include the same the distinguishing marks of the labels; removing the tear tags from the labels before attaching the labels to the plurality of wine glasses; attaching the tear tags to one or more personal items; and identifying the wine glasses by matching the tear tags attached to the one or more personal items with the plurality of labels attached to the plurality of wine glasses.

It should be understood that the methods recited above need not be practiced with each and every step listed.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1A is an illustration in perspective view of one embodiment of the present invention while being peeled off of a bottle.

FIG. 1B is an illustration in perspective view of one embodiment of the present invention while affixed to a glass.

FIG. 2A is an illustration in perspective view of a prior art, non-disposable wine glass label commonly referred to as a “wine charm.”

FIG. 2B is an illustration in perspective view of a prior art, disposable wine glass label.

FIG. 3A is an illustration in perspective view of another embodiment of the present invention prior to the removal of the capsule on a wine bottle.

FIG. 3B is an illustration in perspective view of another embodiment of the present invention following the removal of the capsule on a wine bottle.

FIG. 3C is an illustration in perspective view of another embodiment of the present invention while affixed to a wine glass.

FIG. 3D is an illustration in perspective view of another embodiment of the present invention after being reattached to the wine bottle, for storage.

FIG. 4 is an illustration in perspective view of another embodiment of the present invention that shows how a pull ring with cutting wire can be added to the invention for ease of operation.

FIG. 5A is an illustration in perspective view of another embodiment of the present invention prior to being removed from a wine bottle.

FIG. 5B is an illustration in detail of the back of one of the labels from one embodiment of the present invention.

FIG. 5C is an illustration in perspective view of another embodiment of the present invention while attached to a wine glass.

FIG. 5D is an illustration in detail of the front of another embodiment of the present invention and shows the tear line.

FIG. 5E is an illustration in detail of the back of another embodiment of the present invention and shows the tear line.

FIG. 5F is an illustration in detail of the back of another embodiment of the present invention and shows the label torn at the tear line and the torn tab affixed to a personal item.

FIG. 6A is an illustration in perspective view of another embodiment of the present invention while on a wine bottle.

FIG. 6B is an illustration in detail of the label tab used in this same embodiment of the present invention.

FIG. 7A is an illustration of another embodiment of the present invention while being removed from a wine bottle.

FIG. 7B is an illustration of another embodiment of the present invention while being affixed onto a wine glass.

FIG. 8 is an illustration in perspective view of another embodiment of the present invention prior to being removed from a wine bottle.

FIG. 9 is an illustration in perspective view of another embodiment of the present invention prior to being removed from a wine bottle.

FIG. 10 is an illustration in perspective view of another embodiment of the present invention prior to being removed from a wine bottle.

FIG. 11A is an illustration in perspective view of another embodiment of the present invention while attached and when removed from a wine bottle.

FIG. 11B is an illustration in perspective view of another embodiment of the present invention while attached to the side of a wine glass.

FIG. 11C is an illustration of another embodiment of the present invention.

FIG. 11D is an illustration in perspective view of another embodiment of the present invention while being removed from a screw-cap type wine bottle.

FIG. 11E is an illustration in perspective view of another embodiment of the present invention while attached to the underside of a wine glass.

FIG. 12A is an illustration in perspective view of another embodiment of the present invention while attached to a box of wine.

FIG. 12B is an illustration in perspective view of another embodiment of the present invention while attached to a wine glass.

FIG. 12C is an illustration in detail of the back of one of the labels from one embodiment of the present invention.

FIG. 12D is an illustration in perspective view of another embodiment of the present invention while attached to a cup.

FIG. 13A is an illustration in perspective view of another embodiment of the present invention while attached to a box of wine.

FIG. 13B is an illustration in perspective view of the inside of the label card, another embodiment of the present invention.

FIG. 14A is an illustration in perspective view of another embodiment of the present invention while attached to a box of wine.

FIG. 14B is an illustration in perspective view of the envelope and label card of another embodiment of the present invention.

FIG. 15A is an illustration in perspective view of another embodiment of the present invention while attached to a box of wine.

FIG. 15B is an illustration of several of the varieties of label shapes that may be used in conjunction with the various embodiments of the present invention.

FIG. 16A is an illustration in perspective view of another embodiment of the present invention while attached to a box of wine.

FIG. 16B is an illustration in perspective view of another embodiment of the present invention while attached to a wine glass.

FIG. 16C is an illustration in perspective view of another embodiment of the present invention while being attached to a wine diary.

FIG. 17A is an illustration in perspective view of another embodiment of the present invention while being attached to a wine bottle.

FIG. 17B is an illustration in perspective view of another embodiment of the present invention while being attached to wine glasses.

FIG. 17C is an illustration in perspective view of another embodiment of the present invention while being attached to a wine glass.

FIG. 17D is an illustration in perspective view of another embodiment of the present invention while being attached to a wine bottle.

FIG. 18 is an illustration in perspective view of another embodiment of the present invention that shows a capsule pull tab.

### DETAILED DESCRIPTION OF THE DRAWINGS

In the following detailed description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance “bottle” refers to any dispenser or container used to dispense a material and “glass” includes any vessel into which a material is poured.

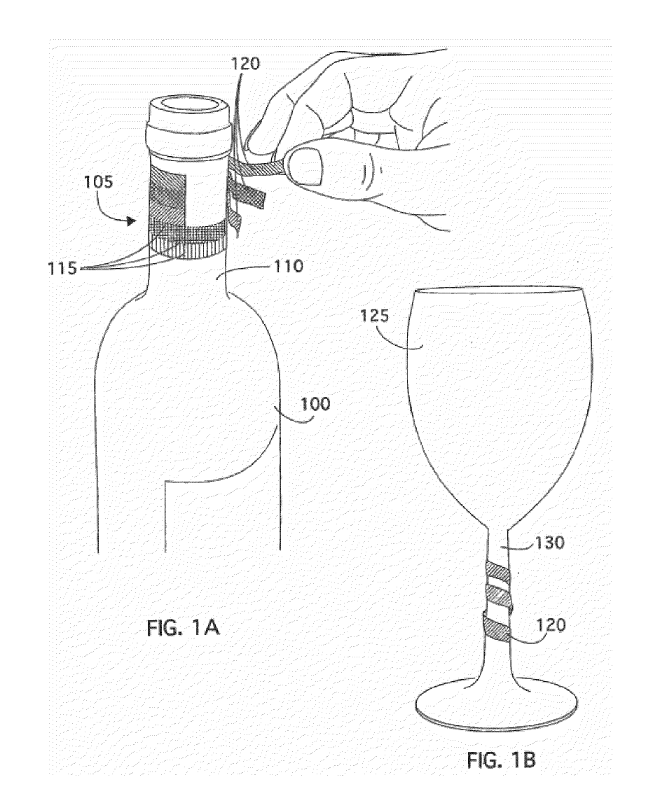

FIG. 1A is an illustration in perspective view of one embodiment of the present invention while being peeled off of a wine bottle. As show in FIG. 1A, a wine bottle 100 is packaged to include an array of re-attachable container identifiers 105 at the neck of the bottle 110, that can be concealed under the capsule or foil of the bottle or be integral to the capsule itself. The array of re-attachable container identifiers 105 is perforated 115 to allow easy removal of individual re-attachable container identifiers, 120. In this diagram, a re-attachable container identifier 120 is shown being removed from the array of re-attachable container identifiers 105 by pulling along the perforations. The re-attachable container identifiers 120 can be each colored differently, in order to allow differentiation among wine glasses, once they affixed to wine glasses Also, re-attachable container identifiers 120 can also include information about the wine itself such as producer, vintage, or type.

FIG. 1B is an illustration in perspective view of one embodiment of the present invention while affixed to a wine glass. As shown in FIG. 1B, a wine glass 125 with a wine glass stem 130 can have the re-attachable container identifier 120 affixed to it by being wrapped around the wine glass stem 130. The color coding of the re-attachable container identifier along with the text written on it allows a taster to know what wine he is drinking and to differentiate his glass among others.

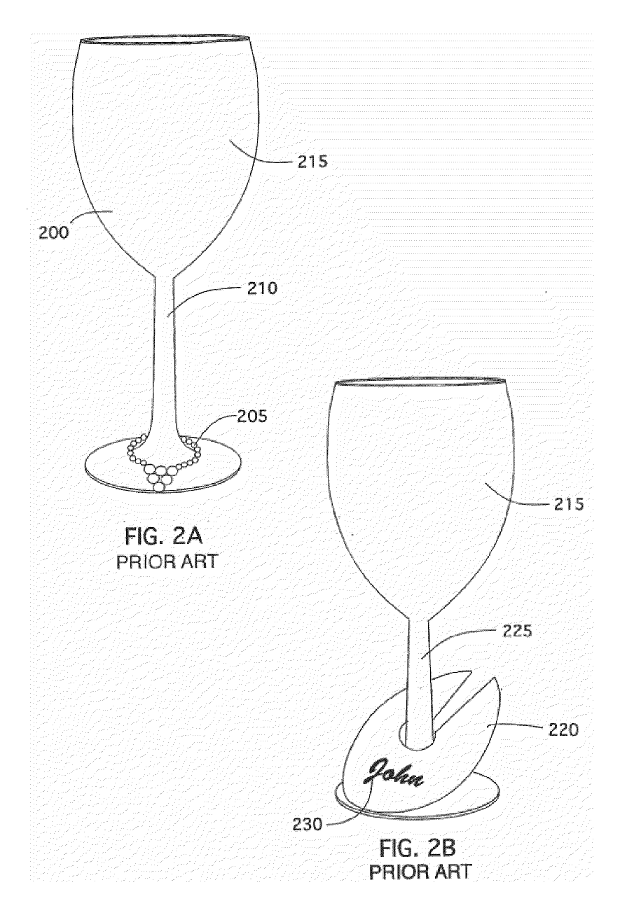

FIG. 2A is an illustration in perspective view of a prior art, non-disposable wine glass label commonly referred to as a “wine charm.” A wine glass 200 is shown with a non-disposable re-attachable container identifier 205 that acts as a necklace that is hung around the wine glass stem 210. By using differing designs and colors for the non-disposable re-attachable container identifier, they can be used to differentiate among different tasters' glasses.

FIG. 2B is an illustration in perspective view of a prior art, disposable wine glass label. As shown in FIG. 2B, a wine glass 215 is shown with a disposable wine glass label 220 that can be affixed to the wine glass stem 225 and have the name of the taster or other information written on the disposable wine glass label 230. This allows the taster to identify his or her glass and/or the type of wine in the glass.

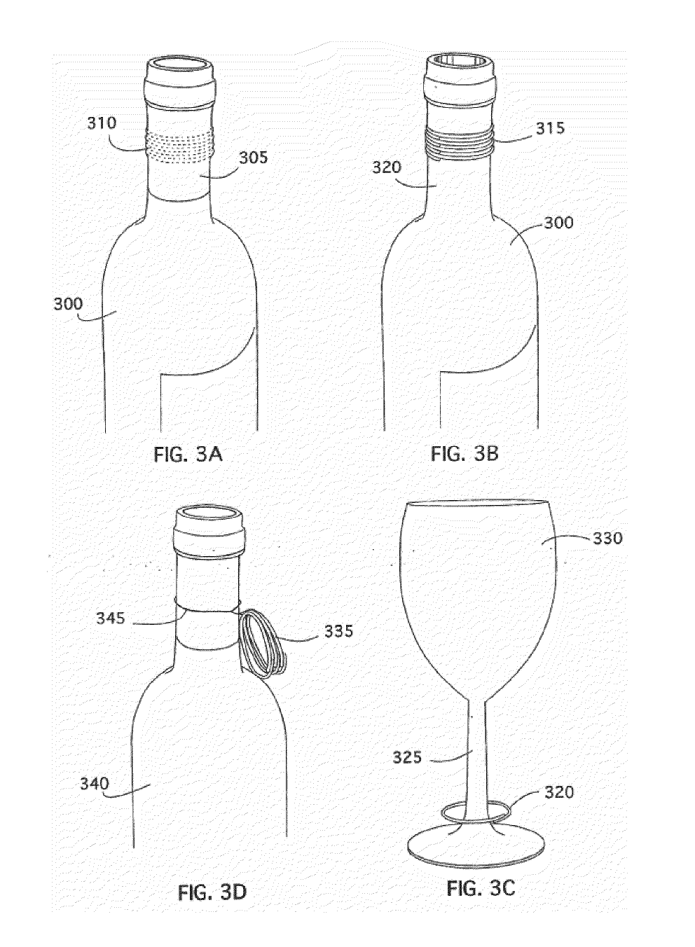

FIG. 3A is an illustration in perspective view of another embodiment of the present invention prior to the removal of the capsule on a wine bottle. As shown in FIG. 3A, a wine bottle 300 is shown with the capsule 305 not removed. The impression 310 of ring-shaped labels is visible on the capsule 305.

FIG. 3B is an illustration in perspective view of another embodiment of the present invention following to the removal of the capsule on a wine bottle. The wine bottle 300 is shown without the capsule in FIG. 3A. In this illustration, the ring-shaped labels 315 are visible as affixed on the neck of the wine bottle 320.

FIG. 3C is an illustration in perspective view of another embodiment of the present invention while affixed to a wine glass. As shown in FIG. 3C, and individual ring-shaped label 320 can be affixed to the stem 325 of a wine glass 330.

FIG. 3D is an illustration in perspective view of another embodiment of the present invention after being reattached to the wine bottle, for storage. In this illustration, ring-shaped labels 335 are attached to a wine bottle 340 using a wire or string 345.

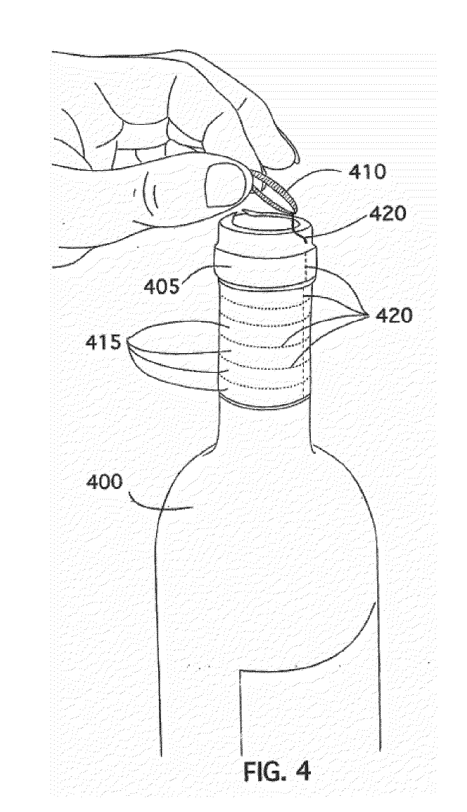

FIG. 4 is an illustration in perspective view of another embodiment of the present invention that shows how a pull ring can be added to the invention for ease of operation. A wine bottle 400 is shown with the capsule 405 not yet removed. A pull ring 410 is included with the capsule 405 to facilitate easier removal of the re-attachable container identifiers 415. The pull ring 410 is attached to a string 420 which separates the re-attachable container identifiers 415 along the perforations 420 on the capsule 405.

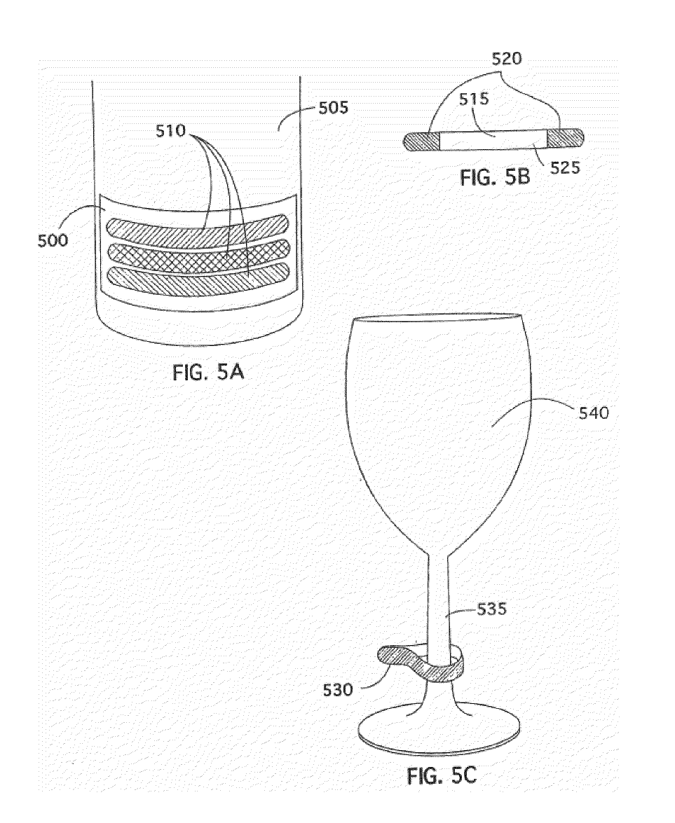

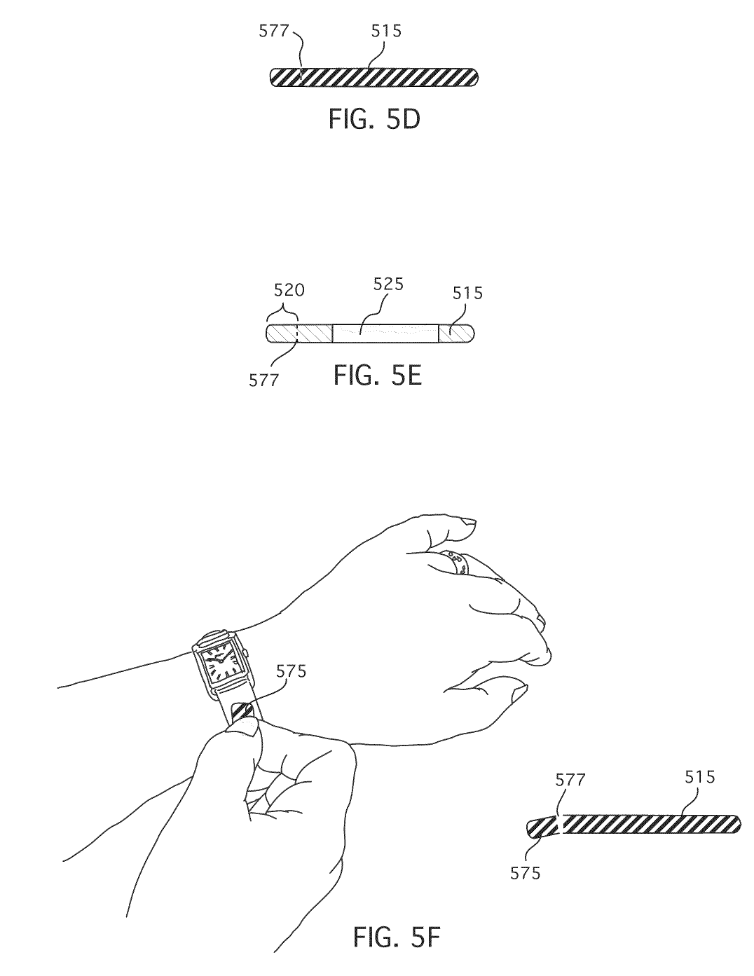

FIG. 5A is an illustration in perspective view of another embodiment of the present invention prior to being removed from a wine bottle. As shown in FIG. 5A, the back label 500 of a wine bottle 505 includes a number of removable labels 510. The labels can be printed in different colors and include information about the vineyard, type, year, or other information about the wine.

FIG. 5B is an illustration in detail of the back of one of the labels from one embodiment of the present invention. As shown in FIG. 5B, the back of a removable label 515 features two sticky portions 520 at either end of the label. The middle portion 525 of back of the label is not sticky, so as not to attach to the stem of a wine glass.

FIG. 5C is an illustration in perspective view of another embodiment of the present invention while attached to a wine glass. FIG. 5C shows a label 530 affixed to the stem 535 of a wine glass 540. The front of the label is facing outwards, allowing one to see the color of the label and any words printed thereon.

FIG. 5D is an illustration in detail of the front of another embodiment of the present invention and shows the tear line. As shown in FIG. 5D, removable label 515 has a tear line 577. This tear line allows the label to be easily torn so that a small part of the label can be placed on a personal item. This makes it easier for the drinker to remember which labeled wine glass is theirs. FIG. 5D shows that the part removed from the label preferably has the same distinguishing marks as the rest of the label.

FIG. 5E is an illustration in detail of the back of another embodiment of the present invention and shows the tear line. As shown in FIG. 5E, the back of label 515 has non-adhesive area 525 between two adhesive areas. Tear line 577 is within one of the adhesive areas. Thus when tab 520 is detached along tear line 577, it preferably has adhesive on the back.

FIG. 5F is an illustration in detail of the back of another embodiment of the present invention and shows the label 515 torn at the tear line 577 and the torn tab 575 is affixed to a personal item, such as a watch.

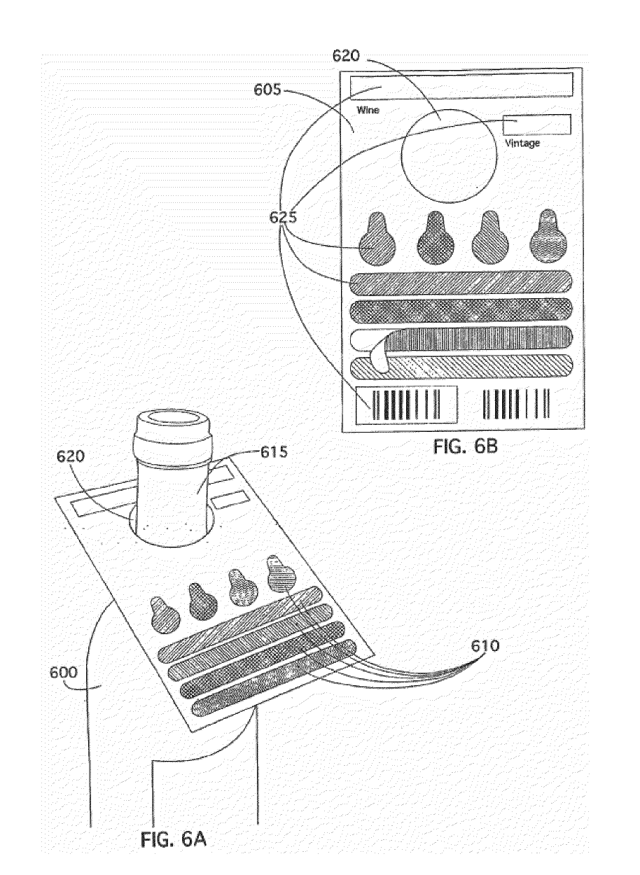

FIG. 6A is an illustration in perspective view of another embodiment of the present invention while on a wine bottle. As shown in FIG. 6A, a wine bottle 600 can hold a label card 605 containing several individual labels 610 on the neck 615 of the wine bottle 600 when the label card 605 includes a hole 620, through which the neck of a wine bottle can be inserted. The label card can operate in a similar fashion as those of other embodiments in order to designate the wine type and distinguish the taster's glass.

FIG. 6B is an illustration in detail of the label card used in this same embodiment of the present invention. As shown in FIG. 6B, a label card 605 can include several lift off labels 625 that can identify different aspects of the wine and be used to label glasses or to log the wine for future reference by the taster. Also, the label card 605 includes a hole 620 through which the neck of a wine bottle can be inserted.

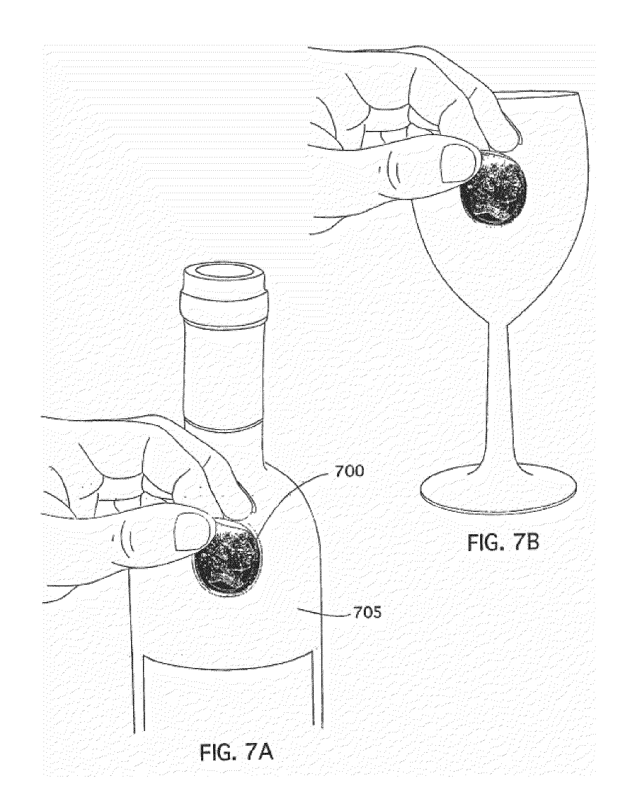

FIG. 7A is an illustration of another embodiment of the present invention while being removed from a wine bottle. As shown in FIG. 7A, a cameo 700 is being removed from a wine bottle 705. The cameo 700 can now be affixed onto a wine glass in order to identify the source of the wine poured into the glass.

FIG. 7B is an illustration of another embodiment of the present invention while being affixed onto a wine glass. A cameo 705 is being affixed to a wine glass 710 in order to identify the wine poured into the glass as coming from the wine bottle 705.

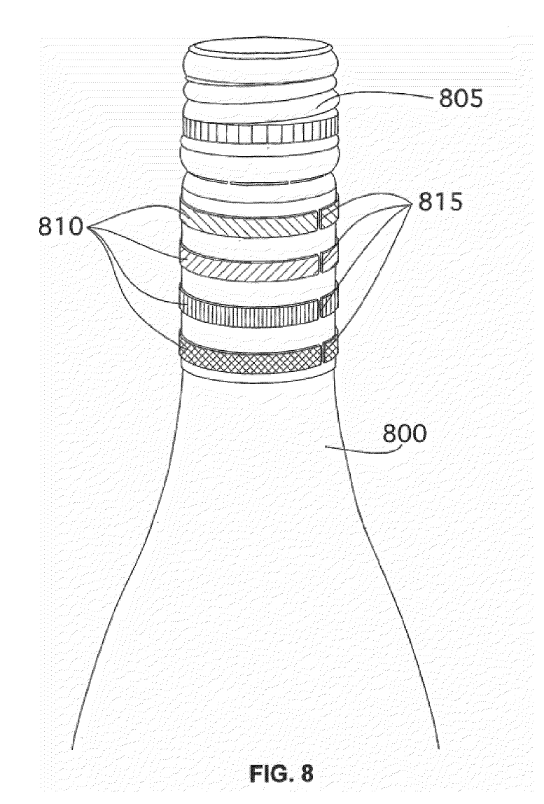

FIG. 8 is an illustration in perspective view of another embodiment of the present invention prior to being removed from a wine bottle. A wine bottle 800 is shown with a screw cap 805 and several re-attachable container identifiers 810 around the capsule of the wine bottle. The re-attachable container identifiers 810 are color coded in order to distinguish the wine glasses onto which they will be attached. The re-attachable container identifiers 815 also feature a slit 815 that allows them to be easily removed from the wine bottle 810 and re-attached to a wine glass.

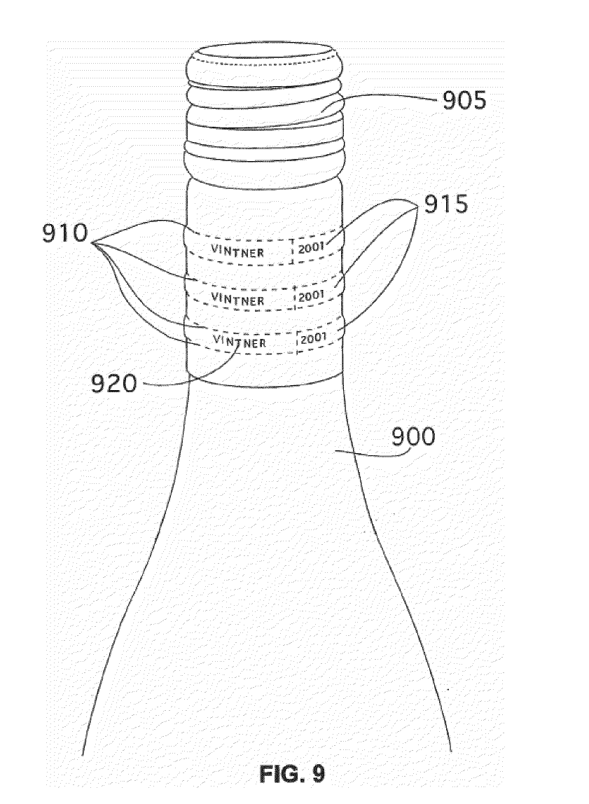

FIG. 9 is an illustration in perspective view of another embodiment of the present invention prior to being removed from a wine bottle. A wine bottle 900 is shown with a screw cap 905 and several re-attachable container identifiers 915 integrated as part of the capsule of the wine bottle. The edges of the re-attachable container identifiers 915 include perforations 910 that allow the re-attachable container identifiers 915 to be more easily removed. The re-attachable container identifiers 915 also include text 920 that serves to identify the producer, vintage, or other information about the wine, once attached to a glass.

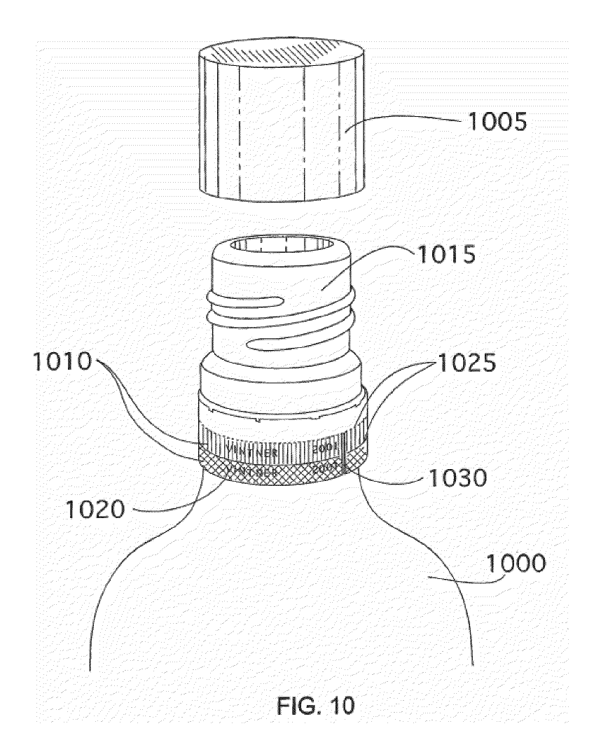

FIG. 10 is an illustration in perspective view of another embodiment of the present invention prior to being removed from a wine bottle. A wine bottle 1000 is shown with a screw cap 1005 that is removed from the bottle cap 1015. Several color coded re-attachable container identifiers 1010 are attached to the neck of the bottle and include text 1020 indicating the producer and vintage of the wine. When removed and attached to a wine glass, these will allow one to distinguish his or her glass among others while identifying the producer and vintage of the wine in the glass. The re-attachable container identifiers also include perforations 1025 and a slit 1030 to allow them to be more easily removed from the bottle.

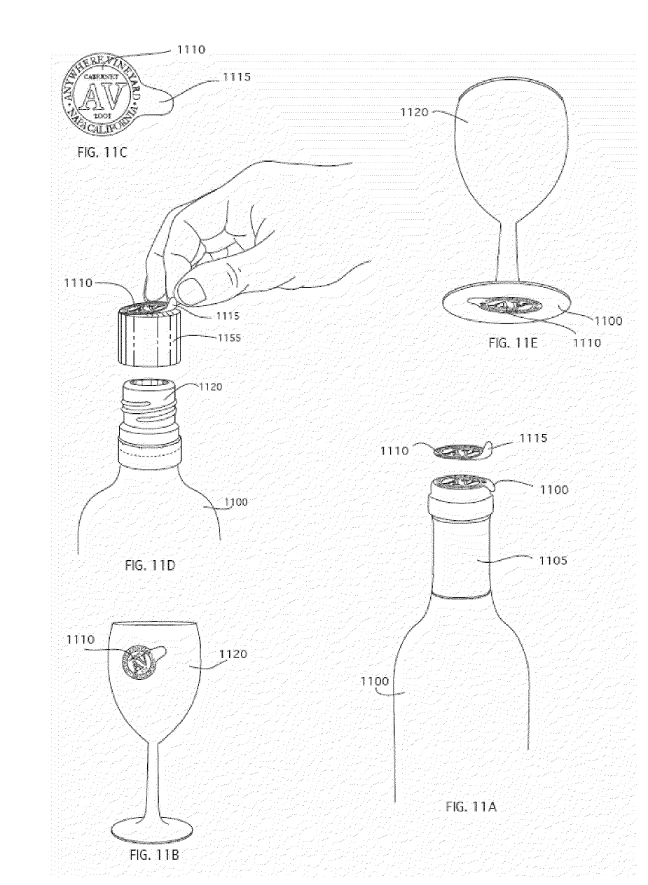

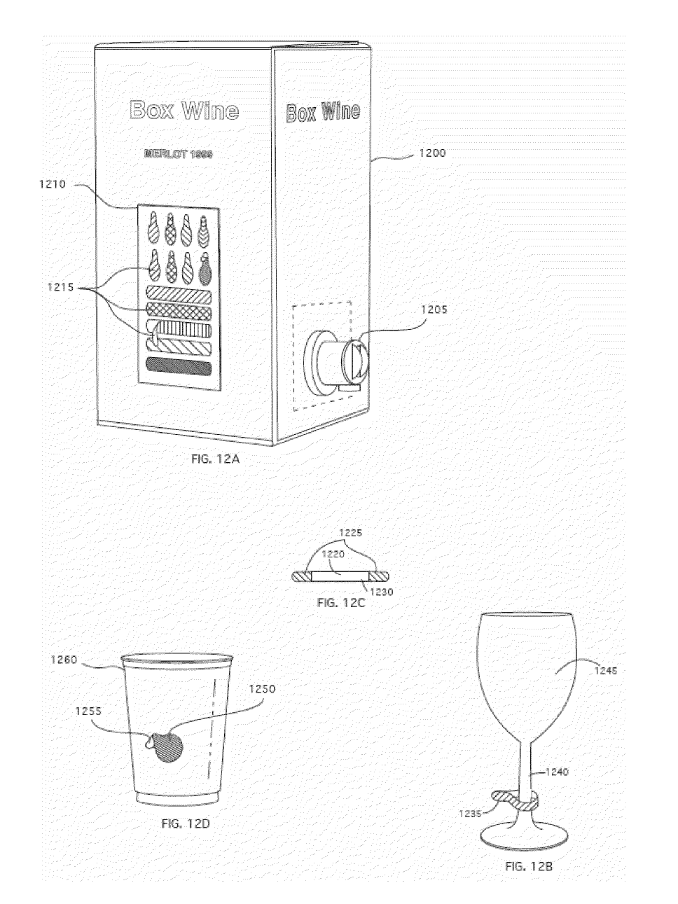

FIG. 11A is an illustration in perspective view of another embodiment of the present invention while attached and when removed from a wine bottle. A wine bottle 1100 is shown with a re-attachable container identifier 1110 still attached to the top of the bottle, above the capsule 1105. Above the bottle is shown a re-attachable container identifier 1110 with a tab 1115 extending outwards to facilitate easier handling of the re-attachable container identifier 1110.

FIG. 11B is an illustration in perspective view of another embodiment of the present invention while attached to the side of a wine glass. A wine glass 1120 is shown with a re-attachable container identifier 1110 attached to its side.

FIG. 11C is an illustration of another embodiment of the present invention. A re-attachable container identifier 1110 is shown with text that indicates the producer and vintage of the wine and a tab 1115 to facilitate easier handling of the re-attachable container identifier 1110.

FIG. 11D is an illustration in perspective view of another embodiment of the present invention while being removed from a screw-cap type wine bottle. A wine bottle 1100 is shown with the screw cap 1125 removed from the bottle cap 1120. The top of the screw cap 1125 includes a re-attachable container identifier 1110 which is being removed by handling the tab 1115.

FIG. 11E is an illustration in perspective view of another embodiment of the present invention while attached to the underside of a wine glass. A wine glass 1120 is shown with a re-attachable container identifier 1110 attached to its underside, as is practiced in a “blind tasting.”

FIG. 12A is an illustration in perspective view of another embodiment of the present invention while attached to a box of wine. A box of wine 1200 and spigot 1205 are shown with a label card 1210, containing re-attachable container identifiers 1215, attached to the side of the box.

FIG. 12B is an illustration in perspective view of another embodiment of the present invention while attached to a wine glass. A label 1235 affixed to the stem 1240 of a wine glass 1245 is shown. The front of the label is facing outwards, allowing one to observe the color of the label or any words printed thereon.

FIG. 12C is an illustration in detail of the back of one of the labels from one embodiment of the present invention. The back of a removable label 1230 features two sticky portions 1225 at either end of the label. The middle portion 1220 of the label is not sticky, so as not to attach to the stem of a wine glass.

FIG. 12D is an illustration in perspective view of another embodiment of the present invention while attached to a cup. A re-attachable container identifier 1250 is attached to the side of the cup 1260 with its tab 1255, which facilitates easier handling, exposed.

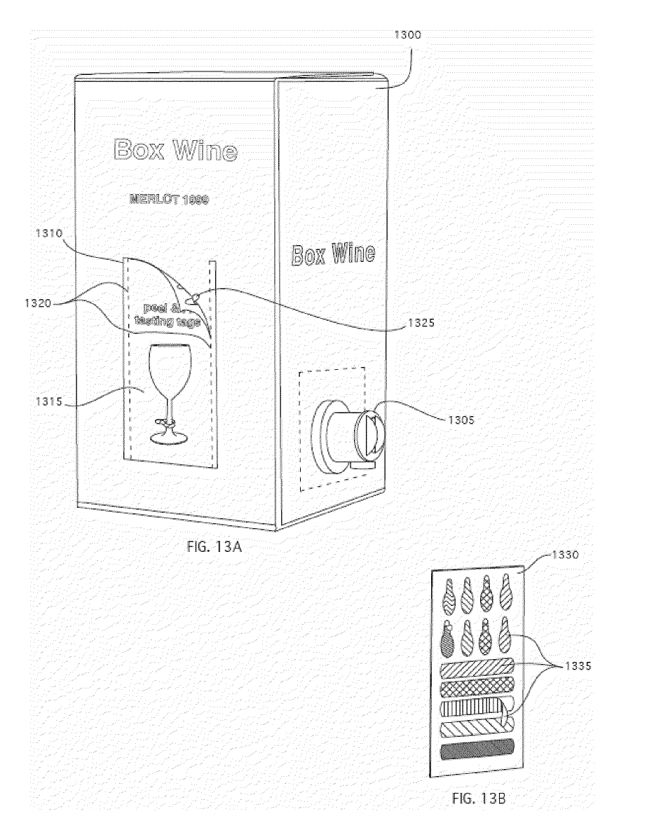

FIG. 13A is an illustration in perspective view of another embodiment of the present invention while attached to a box of wine. A box of wine 1300 with its spigot 1305 is shown with an inwards facing label card 1310 attached to the side of the box 1300. Two vertical perforations 1320 allow the user to remove the label card 1310 from the box 1300. The outside of the label card 1315 may include a graphic diagram or instructions, while the inside of the label card includes the re-attachable container identifiers.

FIG. 13B is an illustration in perspective view of the inside of the label card, another embodiment of the present invention. The label card 1330 includes a variety of shapes and sizes of re-attachable container identifiers 1335, which can feature different colors or text.

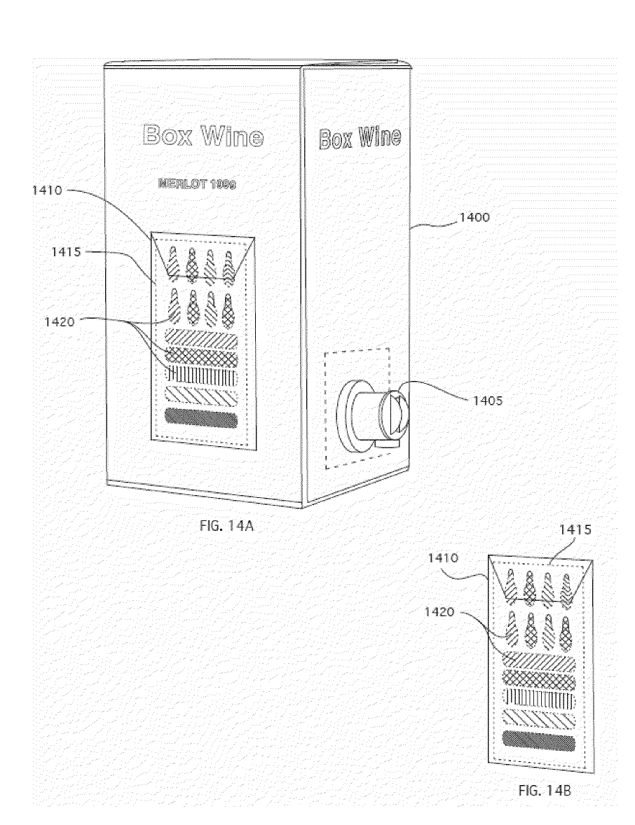

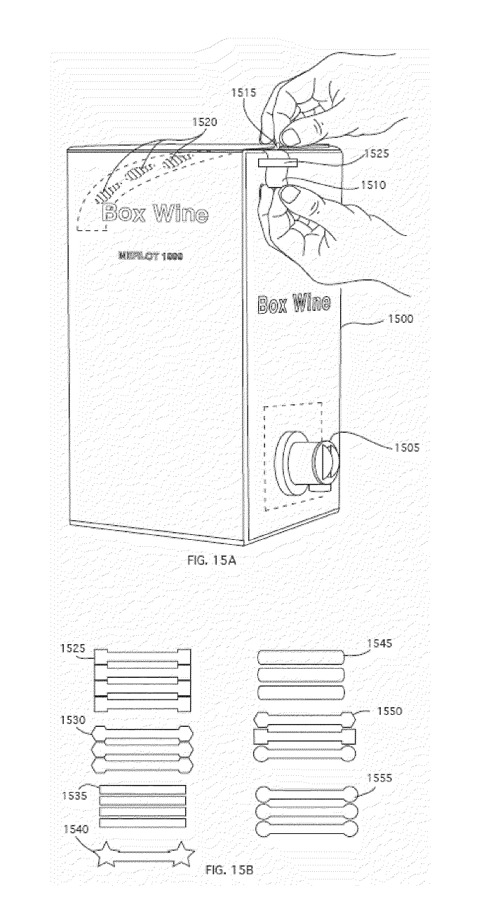

FIG. 14A is an illustration in perspective view of another embodiment of the present invention while attached to a box of wine. A box of wine 1400 is shown with its spigot 1405, an envelope 1410 attached, containing a label card 1415 with numerous re-attachable container identifiers 1420.

FIG. 14B is an illustration in perspective view of the envelope and label card of another embodiment of the present invention. An envelope 1410 is shown with a label card 1415 with numerous re-attachable container identifiers 1420. The envelope 1410 serves to protect the label card 1415 during shipment and storage of the box of wine.

FIG. 15A is an illustration in perspective view of another embodiment of the present invention while attached to a box of wine. A box of wine 1500 is shown with a leader tape 1510 that attaches several re-attachable container identifiers 1520. As shown in the diagram, the user may pull on the leader tape 1510 to expose re-attachable container identifiers 1520 and remove individual re-attachable container identifiers 1520 by pulling on their tabs 1515. The leader tape 1510 passes under a paper or cardboard lug 1525, which forces the leader tape 1510 to make a 90-degree turn and, thereby, facilitates easier removal of the re-attachable container identifiers 1520.

FIG. 15B is an illustration of several of the varieties of label shapes that may be used in conjunction with the various embodiments of the present invention. Dumbbell shaped labels with square ends are marked as 1525. Dumbbell shaped labels with octagonal ends marked as 1530. Rectangle shaped labels are marked as 1535. A dumbbell shaped label with star shaped ends is marked as 1540. Oval shaped labels are marked as 1545. Dumbbell shaped labels with varying shaped ends are marked as 1550. Dumbbell shaped labels with circular ends are marked as 1555.

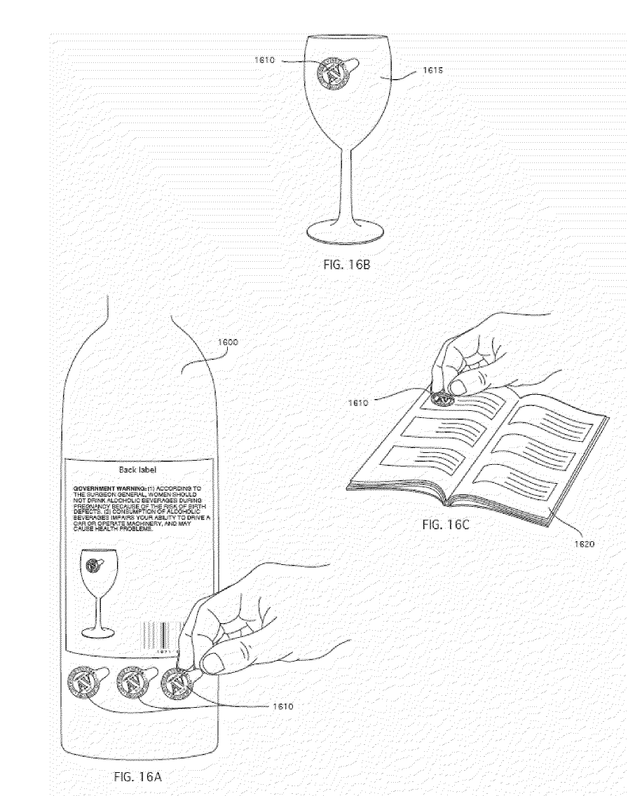

FIG. 16A is an illustration in perspective view of another embodiment of the present invention while attached to a box of wine. The back of a wine bottle 1600 is shown with several re-attachable container identifiers 1610 attached and the user removing one of the re-attachable container identifiers 1610.

FIG. 16B is an illustration in perspective view of another embodiment of the present invention while attached to a wine glass. A wine glass 1615 is shown with a re-attachable container identifier 1610 attached to its side.

FIG. 16C is an illustration in perspective view of another embodiment of the present invention while being attached to a wine diary. A wine diary 1620 is shown with the user placing a re-attachable container identifier 1610 onto its pages. The user is, thus, able to keep the re-attachable container identifier 1610 after it was attached to his or her glass in order to maintain a log of the wines tasted.

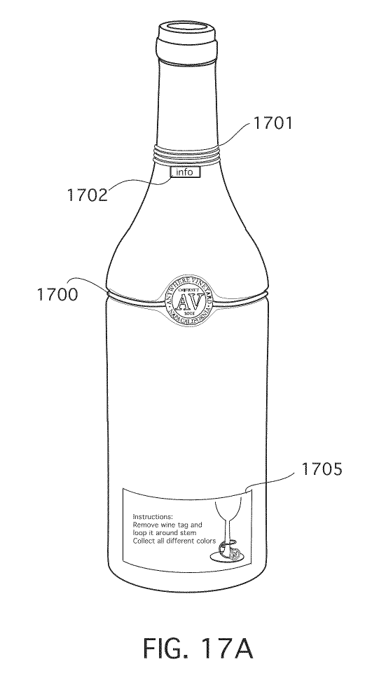

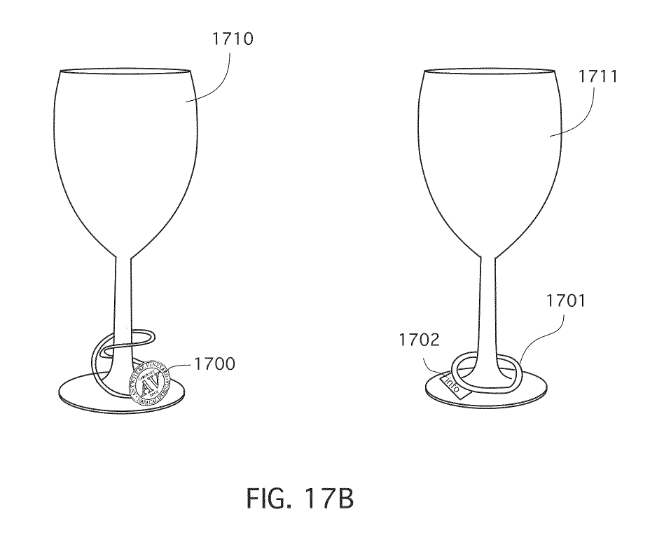

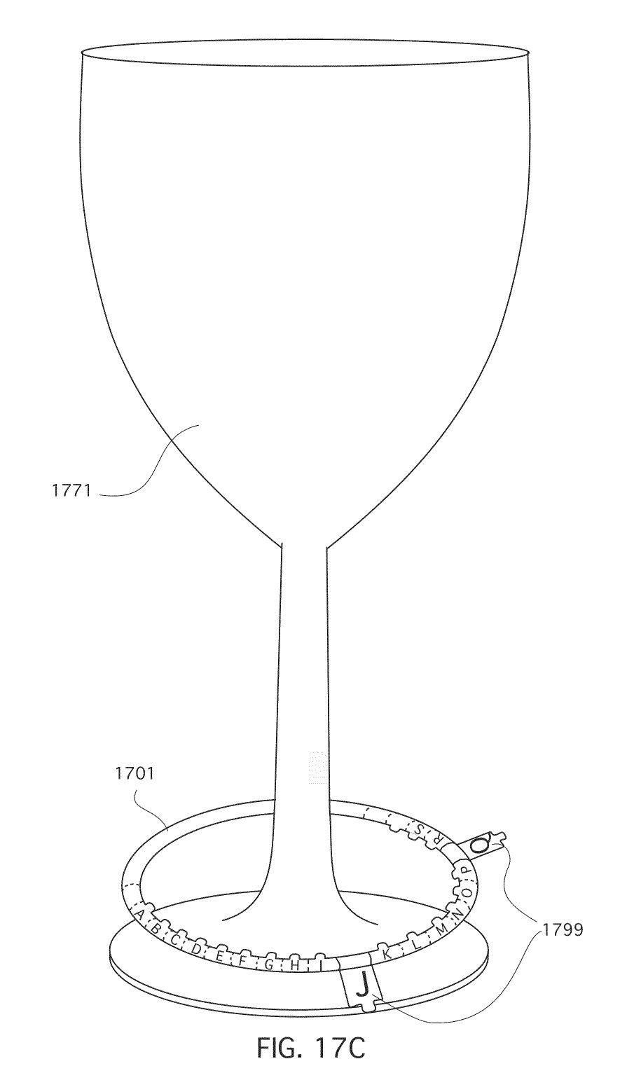

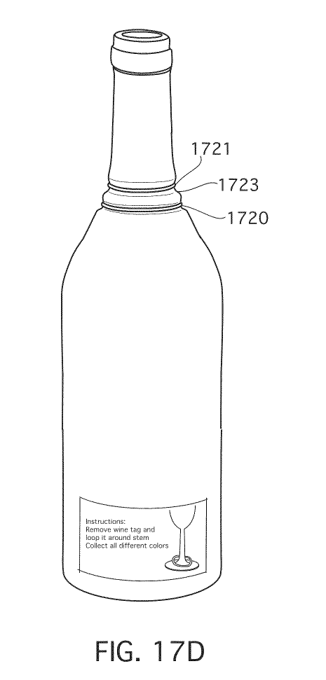

FIG. 17A is an illustration in perspective view of another embodiment of the present invention while being attached to a wine bottle. As shown in FIG. 17A, the re-attachable container identifier may be a bands or elastic bracelet rings 1700 or 1701. FIG. 17A shows the elastic bracelet ring 1700 on the body of the bottle 1703 and elastic bracelet ring 1701 on the neck of the bottle 1703. Elastic bracelet ring 1701 is shown is an informational tag 1702 that gives the user additional information about the wine. FIG. 17A also shows how the elastic bracelet rings 1700 and 1701 may be inset into a shaped glass overhang that protects the elastic bracelet rings during transportation. Preferably the instructions 1705 for how to remove and use the elastic bracelet rings 1700 and 1701 are affixed as a label on the wine bottle. Although FIG. 17A shows bracelet ring 1700 with a cameo, the bracelet may have no cameo, or may have some other identification tab without deviating from the scope of the invention.

FIG. 17B is an illustration in perspective view of another embodiment of the present invention while being attached to wine glasses. FIG. 17B shows that elastic bracelet rings 1700 and 1701 have been removed from the bottle and attached to wine glasses 1710 and 1711. The informational tag 1702 gives the drinker additional information about the wine being enjoyed.

FIG. 17C is an illustration in perspective view of another embodiment of the present invention while being attached to a wine glass. FIG. 17C shows how the information tag 1799 on elastic bracelet ring 1701 may be an alphabet that allows the drinker of wine glass 1711 to unwrap the drinker's initials, thus identifying that glass as the drinker's glass. Preferably the letters are unwrapped to expose the initials as informational tabs. Although FIG. 17C shows initials, the information contained on the tab can be any combination of characters or numbers. Preferably these characters or numbers aid the drinker in identifying the wine being drunk or in identifying the wine glass as the drinker's.

FIG. 17D is an illustration in perspective view of another embodiment of the present invention while being attached to a wine bottle. FIG. 17D shows how the elastic bracelet rings 1720 and 1721 may be nested in ripples 1723 and 1724. Ripples 1723 and 1724 are located at the shoulder of wine bottle 1725, which will allow the ripples 1723 and 1724 to trap sediments that settle out of the wine.

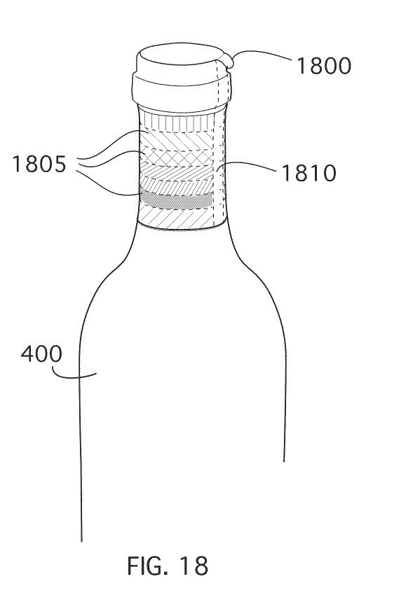

FIG. 18 is an illustration in perspective view of another embodiment of the present invention that shows a capsule pull tab. A wine bottle 400 is shown with a capsule that has a pull tab 1800 that facilitates the easier removal of the re-attachable container identifiers 1805. The pull tab 1800, when pulled removes vertical tab 1810, which preferably runs the entire height of the capsule. As shown in FIG. 18, the container identifiers 1805 preferably have distinguishing marks that allow different drinkers to identify their glass. Alternatively, the distinguishing marks may be on the inside of the capsule so that the capsule has a standard and uniform appearance.

A wine bottle can hold a label cylinder containing several individual labels on the neck of the wine bottle. The label cylinder can operate in a similar fashion as those of other embodiments in order to designate the wine type and distinguish the taster's glass and to include diagrams or instructions on the use of re-attachable container identifiers. Also, the label cylinder can be used in conjunction with more re-attachable container identifiers on the back label of a wine bottle.

A wine bottle can hold a label cone containing several individual labels on the neck of the wine bottle. The label cone can operate in a similar fashion as those of other embodiments in order to designate the wine type and distinguish the taster's glass and to include diagrams or instructions of the use of re-attachable container identifiers. Also, the label cylinder can be used in conjunction with more re-attachable container identifiers on the back label of a wine bottle.

Another embodiment of the invention is a method of identifying wine in a wine glass, the steps comprising: providing a wine bottle; wherein the wine bottle has one or more labels; wherein the one or more labels have identifying marks that identify a wine contained in the wine bottle; wherein the labels are removable; providing one or more wine glasses; attaching the removable labels to the wine glasses; pouring the wine into the wine glasses with the removable labels; and using the removable label to identify the wine poured into the wine glasses.

Preferably, the identifying marks are selected from the group consisting of colors, patterns, symbols, characters, letters, and words. Preferably, the labels further comprise distinguishing marks. The method may also includes the steps of: distinguishing the labeled wine glasses from one another by the distinguishing marks; wherein the distinguishing marks are preferably selected from the group consisting of colors, patterns, symbols, characters, letters, and words; wherein the wine glasses have stems; attaching the removable labels to the stems such that the labels completely encircle the stems; wherein the labels include tear tags; wherein the tear tags include the same the distinguishing marks of the labels; removing the tear tags from the labels before attaching the labels to the plurality of wine glasses; attaching the tear tags to one or more personal items; and identifying the wine glasses by matching the tear tags attached to the one or more personal items with the plurality of labels attached to the plurality of wine glasses.

Another embodiment of the invention is a method of distinguishing among wine glasses into which a wine is transferred from a wine bottle, the steps comprising: providing a wine bottle; wherein the wine bottle has a plurality of labels; wherein the plurality of labels have distinguishing marks; wherein the labels are removable; providing a plurality of wine glasses; attaching the removable labels to the wine glasses such that each of the plurality of wine glasses has a different one of the distinguishing marks. The method may also include the steps of pouring the wine into the wine glasses with the removable labels; distinguishing the labeled wine glasses from one another by the distinguishing marks; wherein the distinguishing marks are selected from the group consisting of colors, patterns, symbols, characters, letters, and words; wherein the wine glasses have stems; attaching the removable labels to the stems such that the labels completely encircle the stems; wherein the labels include tear tags; wherein the tear tags include the same the distinguishing marks of the labels; removing the tear tags from the labels before attaching the labels to the plurality of wine glasses; attaching the tear tags to one or more personal items; and identifying the wine glasses by matching the tear tags attached to the one or more personal items with the plurality of labels attached to the plurality of wine glasses.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

We claim:

1. A product for identifying wine, comprising,
a wine bottle;
one or more labels
wherein said one or more labels are affixed to said wine bottle;
wherein said one or more labels are removable;
wherein said one or more labels have one or more identifying marks;
wherein said one or more labels are removed from said wine bottle and are affixed to one or more wine glasses into which a wine from said wine bottle is poured; and
wherein said one or more identifying marks identify said wine poured from said wine bottle.

2. The product for identifying wine according to claim 1, wherein said identifying marks are selected from the group consisting of colors, patterns, symbols, characters, letters, and words.

3. The product for identifying wine according to claim 2, wherein there are two or more wine glasses and two or more labels and wherein said two or more labels have distinguishing marks; and
wherein said distinguishing marks allow a user to differentiate between said two or more wine glasses into which said wine from said wine bottle is poured.

4. The product for identifying wine according to claim 3, wherein said distinguishing marks are different colors, and said different colors are used to distinguish between said two or more wine glasses into which said wine from said wine bottle is poured.

5. The product for identifying wine according to claim 1, wherein said one or more wine glasses have stems; and
wherein said one or more labels are affixed to said one or more wine glasses by wrapping said one or more labels around said stems such that at least a portion of said stems is completely encircled by one of said one or more labels.

6. The product for identifying wine according to claim 4, wherein said two or more wine glasses have stems; and
wherein said two or more labels are separately affixed to said two or more wine glasses by wrapping said labels around said stems such that at least a portion of said stems is completely encircled by one of said one or more labels.

7. The product for identifying wine poured into wine glasses according to claim 5, wherein said wine bottle further comprises a capsule;
wherein said one or more labels are derived from said capsule of said wine bottle.

8. The product for identifying wine poured into wine glasses according to claim 6, wherein said wine bottle further comprises a capsule;
wherein said one or more labels are derived from said capsule of said wine bottle.

9. The product for identifying wine poured into wine glasses according to claim 7, wherein said one or more labels derived from said capsule have said one or more identifying marks on an inside surface to prevent changing a standard look of said capsule.

10. The product for identifying wine poured into wine glasses according to claim 8, wherein said two or more labels derived from said capsule have said identifying marks and said different colors on an inside surface to prevent changing a standard look of said capsule.

11. The product for identifying wine poured into wine glasses according to claim 9, wherein said capsule further comprises a pull ring; and
wherein said pull ring facilitates removal of said capsule and separation of said one or more labels.

12. The product for identifying wine poured into wine glasses according to claim 10, wherein said capsule further comprises a pull ring; and
wherein said pull ring facilitates removal of said capsule and separation of said two or more labels.

13. The product for identifying wine poured into wine glasses according to claim 1, wherein said one or more labels are part of and derived from said one or more standard wine bottle labels included on a standard wine bottle.

14. The product for identifying wine poured into wine glasses according to claim 4, wherein said two or more labels are part of and derived from said one or more standard wine bottle labels included on a standard wine bottle.

15. The product for identifying wine poured into wine glasses according to claim 1, wherein said bottle further comprises a neck;
wherein said one or more labels are part of and derived from a label cylinder that is packaged with said wine bottle; and
wherein said label cylinder wraps around said neck of said wine bottle.

16. The product for identifying wine poured into wine glasses according to claim 4, wherein said bottle further comprises a neck;
wherein said two or more labels are part of and derived from a label cylinder that is packaged with said wine bottle; and
wherein said label cylinder wraps around said neck of said wine bottle.

17. The product for identifying wine poured into wine glasses according to claim 1, wherein said bottle further comprises a neck;
wherein said one or more labels are part of and derived from a label cone that is packaged with said wine bottle; and
wherein said label cone wraps around said neck of said wine bottle.

18. The product for identifying wine poured into wine glasses according to claim 4, wherein said bottle further comprises a neck;
wherein said two or more labels are part of and derived from a label cone that is packaged with said wine bottle; and
wherein said label cone wraps around said neck of said wine bottle.

19. A product for distinguishing among wine glasses into which a wine is transferred from a wine bottle, comprising:
a wine bottle;
a plurality of wine glasses
wherein said wine bottle has a plurality of labels;
wherein said plurality of labels are removable;
wherein said plurality of labels have distinguishing marks;
wherein said plurality of labels are removed from said wine bottle and are affixed to said plurality of wine glasses such that each of said plurality of wine glasses has a different one of said distinguishing marks; and
wherein said distinguishing marks allow a user to distinguish among said plurality of wine glasses.

20. The product for distinguishing among wine glasses into which a wine is transferred from a wine bottle according to claim 19, wherein said distinguishing marks are selected from the group consisting of colors, patterns, symbols, characters, letters, and words.

21. The product for distinguishing among wine glasses into which a wine is transferred from a wine bottle according to claim 20, wherein said plurality of wine glasses have stems; and
wherein said plurality of labels are affixed to said one or more wine glasses by wrapping said plurality of labels around said stems such that at least a portion of said stems is completely encircled by one of said plurality of labels.

22. The product for distinguishing wine glasses into which wine is poured according to claim 20, wherein said wine bottle further comprises a capsule;
wherein said one or more labels are derived from said capsule of said wine bottle.

23. The product for distinguishing wine glasses into which wine is poured according to claim 22, wherein said plurality of labels derived from said capsule have said distinguishing marks on an inside surface to prevent changing a standard look of said capsule.

24. The product for distinguishing wine glass into which wine is poured according to claim 23, wherein said capsule further comprises a pull ring; and
wherein said pull ring facilitates removal of said capsule and separation of said plurality of labels.

25. The product for distinguishing wine glass into which wine is poured according to claim 20, wherein said plurality of labels are part of and derived from a plurality of standard wine bottle labels included on a standard wine bottle.

26. The product for identifying wine poured into wine glasses according to claim 20, wherein said wine bottle further comprises a neck;
wherein said plurality of labels are part of and derived from a label cylinder that is packaged with said wine bottle; and
wherein said label cylinder wraps around said neck of said wine bottle.

27. The product for identifying wine poured into wine glasses according to claim 20, wherein said plurality of labels are part of and derived from a label cone that is packaged with said wine bottle; and
wherein said label cone wraps around a neck of said wine bottle.

28. The product for identifying wine poured into wine glasses according to claim 6, wherein said two or more labels have tear tags;
wherein said tear tags include the same said distinguishing marks of said labels;
wherein said tear tags are removed from said labels before said labels are affixed to said plurality of wine glasses;
wherein said tear tags are affixed to one or more personal items; and
wherein said tear tags allow a drinker to identify said two or more wine glasses by matching said tear tags with said labels wrapped around said stems.

29. The product for identifying wine poured into wine glasses according to claim 28, wherein said tear tags are scored.

30. The product for identifying wine poured into wine glasses according to claim 21, wherein said plurality of labels have tear tags;
wherein said tear tags include the same said distinguishing marks of said labels;
wherein said tear tags are removed from said labels before said labels are affixed to said plurality of wine glasses;
wherein said tear tags are affixed to one or more personal items; and
wherein said tear tags allow a drinker to identify said plurality of wine glasses by matching said tear tags with said labels wrapped around said stems.

31. The product for identifying wine poured into wine glasses according to claim 30, wherein said tear tags are scored.

32. A method of identifying wine in a wine glass, the steps comprising: providing a wine bottle;
wherein said wine bottle has one or more labels;
wherein said one or more labels have identifying marks that identify a wine contained in said wine bottle;
wherein said labels are removable;
providing one or more wine glasses;
attaching said removable labels to said wine glasses;
pouring said wine into said wine glasses with said removable labels; and
using said removable label to identify said wine poured into said wine glasses.

33. The method of identifying wine in a wine glass of claim 32, wherein said identifying marks are selected from the group consisting of colors, patterns, symbols, characters, letters, and words

34. The method of identifying wine in a wine glass of claim 33, wherein said labels further comprise distinguishing marks;
distinguishing said labeled wine glasses from one another by said distinguishing marks.

35. The method of identifying wine in a wine glass of claim 34, wherein said distinguishing marks are selected from the group consisting of colors, patterns, symbols, characters, letters, and words.

36. The method of identifying wine in a wine glass of claim 35, wherein said wine glasses have stems;
attaching said removable labels to said stems such that at least a portion of said labels completely encircle said stems.

37. The method of identifying wine in a wine glass of claim 36, wherein said labels include tear tags;
wherein said tear tags include the same said distinguishing marks of said labels;
removing said tear tags from said labels before attaching said labels to said plurality of wine glasses;
attaching said tear tags to one or more personal items; and
identifying said wine glasses by matching said tear tags attached to said one or more personal items with said plurality of labels attached to said plurality of wine glasses.

38. A method of distinguishing among wine glasses into which a wine is transferred from a wine bottle, the steps comprising:
providing a wine bottle;
wherein said wine bottle has a plurality of labels;
wherein said plurality of labels have distinguishing marks;
wherein said labels are removable;
providing a plurality of wine glasses;
attaching said removable labels to said wine glasses such that each of said plurality of wine glasses has a different one of said distinguishing marks;
pouring said wine into said wine glasses with said removable labels; and
distinguishing said labeled wine glasses from one another by said distinguishing marks.

39. The method of distinguishing among wine glasses into which a wine is transferred from a wine bottle of claim 38, wherein said distinguishing marks are selected from the group consisting of colors, patterns, symbols, characters, letters, and words.

40. The method of distinguishing among wine glasses into which a wine is transferred from a wine bottle of claim 39, wherein said wine glasses have stems;
attaching said removable labels to said stems such that at least a portion of said labels completely encircle said stems.

41. The method of distinguishing among wine glasses into which a wine is transferred from a wine bottle of claim 36, wherein said labels include tear tags;
wherein said tear tags include the same said distinguishing marks of said labels;
removing said tear tags from said labels before attaching said labels to said plurality of wine glasses;
attaching said tear tags to one or more personal items; and
identifying said wine glasses by matching said tear tags attached to said one or more personal items with said plurality of labels attached to said plurality of wine glasses.
